(19) United States
(12) Patent Application Publication
(10) Pub. No.: US 2025/0236022 A1
(43) Pub. Date: Jul. 24, 2025

(54) ELECTRONIC DEVICE ASSEMBLY APPARATUS AND ELECTRONIC DEVICE ASSEMBLY METHOD

(71) Applicant: NACHI-FUJIKOSHI CORP., Tokyo (JP)

(72) Inventors: Kei MIKAMI, Toyama (JP); Daisaku UCHIJIMA, Toyama (JP); Kyotaro MIMURA, Toyoma (JP)

(73) Assignee: NACHI-FUJIKOSHI CORP., Tokyo (JP)

(21) Appl. No.: 18/583,890

(22) PCT Filed: Jun. 17, 2022
(86) PCT No.: PCT/JP2022/024292

§ 371 Date: Feb. 22, 2024

(30) Foreign Application Priority Data
Jul. 2, 2021 (JP) 2021-110783

(51) Int. Cl. B25J 11/00; H01R 43/26

(52) U.S. Cl. CPC B25J 11/005; H01R 43/26

(57) ABSTRACT

To provide an electronic device assembly apparatus and an electronic device assembly method enabling a quick connection work by making a lying cable stand up with a simple configuration. An electronic device assembly apparatus includes: a gripping device gripping a flexible flat cable; a robot arm; and a robot control device controlling operations of the gripping device and the robot arm, wherein the gripping device includes: a guide member having a scooping surface; and a holding member holding the cable guided by the guide member, the robot control device moves the gripping device to a position at which the gripping device faces the cable leading end in a longitudinal direction of the lying cable, brings the scooping surface into contact with the cable leading end, and advances the gripping device toward the circuit board making the cable stand up.

### FIELD OF THE INVENTION

The present invention relates to an electronic device assembly apparatus and an electronic device assembly method for gripping a cable electrically connected to a circuit board of an electronic device or the like.

### BACKGROUND OF THE INVENTION

An electronic device assembly apparatus is an apparatus that is used at a production site such as a plant. The electronic device assembly apparatus performs connection work for electrically connecting a leading end of a flat soft (flexible) cable such as an FPC (Flexible Printed Circuit) or an FFC (Flexible Flat Cable) to a connector (substrate-side connector) on a circuit board, for example. The electronic device assembly apparatus includes a visual device such as a camera, a robot arm, and a controller that controls the visual device and the robot arm.

A cable is a soft elongated object having flexibility, and therefore, deforms in an unpredictable manner when it is bent or pressed. Accordingly, there is variation particularly in the position and posture of the leading end of the cable. It is difficult to recognize the leading end of the cable having such variation with use of the visual device of the electronic device assembly apparatus and to grip the leading end with use of the robot arm and insert the leading end into the substrate-side connector. Therefore, the connection work is performed manually in some cases. However, there is a problem that the work efficiency decreases when accurate aligning between the leading end of the cable and the substrate-side connector is performed manually.

Therefore, the electronic device assembly apparatus is required to accurately grip the leading end of the cable in the connection work for connecting the leading end of the cable to the substrate-side connector, and some technologies have been proposed.

Patent Document 1 describes a control apparatus that controls motions of a robot. This apparatus measures an error between a grip target position and a robot hand with use of a visual sensor and corrects the position of the robot hand by moving the robot hand by an amount corresponding to the error. Patent Document 1 describes repeating the correction operation and the measurement of the error by the visual sensor until the robot hand reaches the grip target position to improve precision.

Patent Document 2 describes a connector gripping apparatus. The connector gripping apparatus grips an intermediate portion of a connector-equipped cable with a gripping portion of a first hand of a first robot, moves the gripping portion of the first hand relative to the cable toward the connector with the gripping portion held in contact with the cable, and restricts the position of the connector within a certain space range. The connector gripping apparatus detects the position and posture of the connector restricted within the certain space range with use of a first visual sensor, and grips the connector with a second hand of a second robot based on the detected position and posture.

Patent Document 3 describes an electronic device assembly method in which a second end portion of a cable is attached to a connector on a circuit board in a state where a first end portion of the cable including the first end portion and the second end portion is connected to an electronic circuit. In this electronic device assembly method, first, a cable holding tool is slid relative to the cable while a portion of the cable is held by the cable holding tool and the position of the cable in a width direction is restricted. Next, the cable holding tool is moved closer to the second end portion, and the second end portion is attached to the connector by moving the cable holding tool relative to the connector.

Namely, in the technologies described in Patent Documents 2 and 3, an intermediate portion of a cable, in which variation in the position and posture is small compared with the leading end of the cable, is held by the robot hand or the cable holding tool in such a manner that the robot hand or the cable holding tool is slidable in a longitudinal direction of the cable, and the robot hand or the cable holding tool is moved in this state to the leading end of the cable that is a final gripping target. Thus, the leading end of the cable, in which variation in the position and posture is large compared with the intermediate portion of the cable, is gripped or held.

### PRIOR ART DOCUMENTS

### Patent Documents

Patent Document 1: Japanese Patent Laid-Open Publication No. 2007-11978
Patent Document 2: Japanese Patent No. 3876234
Patent Document 3: Japanese Patent No. 6500247

### SUMMARY OF THE INVENTION

### Problems to be Solved by the Invention

From the viewpoint of increasing productivity, it is desirable to complete the connection work in a short period of time at a production site. Therefore, in the connection work, it is necessary to detect the position of the leading end of the cable and grip the leading end in a short period of time.

However, in the technology described in Patent Document 1, the correction operation and the measurement of the error by the visual sensor are repeated until the robot hand reaches the grip target position. Moreover, when the cable is to be gripped by the robot hand, the grip target position may shift due to flexible deformation such as bending or twisting, elongation, or contraction of the cable. Therefore, with the technology described in Patent Document 1, there is a risk that it will take time to converge the position of the robot hand to the grip target position that has shifted.

In the technology described in Patent Document 2, the intermediate portion of the connector-equipped cable is gripped by the gripping portion of the first hand of the first robot, and the connector is gripped by the second hand of the second robot based on the position and posture of the connector of the cable detected by the first visual sensor. Accordingly, the technology described in Patent Document 2 requires two robots, which increases the cost.

The technology described in Patent Document 3 is devised to hold a standing cable. However, in an actual production process performed at a production site, a cable that has been connected (soldered) to a substrate is laid down (when the substrate extends substantially horizontally, the cable also extends substantially horizontally). Therefore, in order to apply the technology described in Patent Document 3 to actual connecting work, it is necessary to perform an additional step of making the lying cable stand up in advance.

In view of the above problems, the present invention has an object of providing an electronic device assembly apparatus and an electronic device assembly method with which it is possible to make a lying cable stand up with a simple configuration and to quickly perform the connection work.

### Means to Solve the Problem

In order to solve the above problems, a representative configuration of an electronic device assembly apparatus according to the present invention includes: a gripping device that grips a flexible flat cable including a leading end that is lying substantially horizontally; a robot arm that moves the gripping device relative to a circuit board to which a base of the cable has been electrically connected; and a robot controller that controls operations of the gripping device and the robot arm, wherein the gripping device includes: a guide member having a scooping surface; and a holding member that holds the cable guided by the guide member, the robot controller moves the gripping device to a position at which the gripping device faces the leading end of the cable in a longitudinal direction of the lying cable, brings the scooping surface of the guide member into contact with the leading end of the cable, and further advances the gripping device toward the circuit board to make the cable stand up.

According to the above configuration, even in the case where the base of the cable has been electrically connected to the circuit board and the leading end of the cable is lying substantially horizontally, the cable is caused to stand up by moving the gripping device so as to face the leading end of the lying cable, bringing the scooping surface of the guide member into contact with the leading end of the cable, and further advancing the gripping device toward the circuit board. The cable that has been caused to stand up is guided by the guide member and held by the holding member.

Therefore, according to this configuration, it is possible to make the lying cable stand up with use of the scooping surface of the guide member by simply moving the gripping device, and accordingly, the connection work can be performed quickly.

It is preferable that the holding member includes gripping claws that are operated by an actuator, and the gripping claws hold the cable by sandwiching the cable in a direction intersecting with the longitudinal direction.

In this case, the cable that has been caused to stand up by the scooping surface of the guide member is sandwiched between the gripping claws of the holding member in the direction (e.g., a width direction) intersecting the longitudinal direction of the cable. Therefore, the standing cable can be reliably held.

It is preferable that the gripping device further includes a suction member that is provided in a lower surface of the gripping device and holds the cable by sucking the cable.

In this case, when the cable that has been caused to stand up by the scooping surface of the guide member of the gripping device comes into contact with the lower surface of the gripping device by being folded, for example, it is possible to reliably hold the cable by sucking the cable with use of the suction member.

It is preferable that the robot controller moves the gripping device substantially horizontally to fold the cable that has been caused to stand up, causes the holding member to hold the leading end of the cable, and inserts the leading end of the cable into a connector on the circuit board.

In this case, by simply moving the gripping device substantially horizontally, it is possible to fold the standing cable and insert the leading end of the cable into the connector on the circuit board to complete the connection work.

In order to solve the above problems, a representative configuration of an electronic device assembly method according to the present invention is an electronic device assembly method for inserting a leading end of a flexible flat cable into a connector on a circuit board, the cable including a base that has been connected to the circuit board and the leading end that is lying substantially horizontally, the method including: moving a gripping device that includes: a guide member having a scooping surface; and a holding member that holds the cable guided by the guide member; placing the gripping device so as to face the leading end of the lying cable; bringing the scooping surface of the guide member into contact with the leading end of the cable and advancing the gripping device toward the circuit board to make the cable stand up; and moving the gripping device substantially horizontally to fold the cable that has been caused to stand up, causing the holding member to hold the leading end of the cable, and inserting the leading end of the cable into the connector on the circuit board.

In the above configuration, the gripping device is moved so as to face the leading end of the lying cable, the scooping surface of the guide member is brought into contact with the leading end of the cable, and the gripping device is further advanced toward the circuit board to make the cable stand up. Therefore, it is possible to make the lying cable stand up with use of the scooping surface of the guide member by simply moving the gripping device. Furthermore, according to the above configuration, it is possible to fold the standing cable and insert the leading end of the cable into the connector on the circuit board by simply moving the gripping device substantially horizontally, and thus the connection work can be completed quickly.

### Effects of the Invention

According to the present invention, it is possible to provide an electronic device assembly apparatus and an electronic device assembly method with which the connection work can be performed quickly by making a lying cable stand up with a simple configuration.

### BRIEF EXPLANATION OF THE DRAWINGS

FIG. 1 is an overall configuration diagram of a robot system to which an electronic device assembly apparatus according to an embodiment of the present invention is applied.

FIG. 2 is a diagram showing a part of the electronic device assembly apparatus shown in FIG. 1.

FIG. 3 is a block diagram showing functions of the robot system shown in FIG. 1.

FIG. 4A is a diagram showing a gripping device as viewed from obliquely below.

FIG. 4B is a diagram showing the gripping device as viewed from obliquely above.

FIG. 5 is a diagram showing conditions for making a leading end of a cable stand up with use of the gripping device.

FIG. 6 is a block diagram showing functions of the electronic device assembly apparatus shown in FIG. 3.

FIG. 7A shows a state where the gripping device is positioned so as to face a leading end 106 of a cable.

FIG. 7B shows a state where a scooping surface of a guide member is brought into contact with the leading end of the cable.

FIG. 7C shows a state where the gripping device is advanced substantially horizontally toward a circuit board.

FIG. 7D shows a state where the leading end of the cable has slid upward so as to stand up.

FIG. 7E shows a state where the gripping device has moved upward in such a manner as to fold the standing cable.

FIG. 7F shows a state where the vicinity of the leading end of the folded cable is sandwiched between lower portions of gripping claws.

### EMBODIMENTS OF THE INVENTION

A preferred embodiment of the present invention is described below in detail with reference to the attached drawings. Dimensions, materials, other specific numerical values, and the like described in the embodiment are merely examples for facilitating understanding of the present invention, and do not limit the present invention unless otherwise stated. In the specification and the drawings, elements that have substantially the same function and configuration are denoted by the same reference numeral, and a redundant description of such elements is omitted. Also, illustration of elements that do not directly relate to the present invention is omitted.

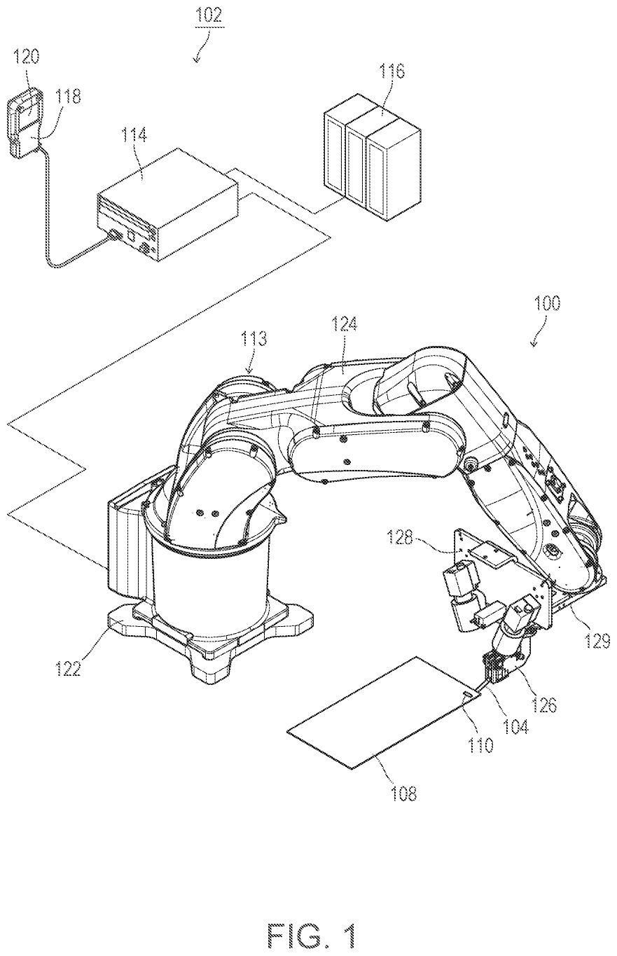

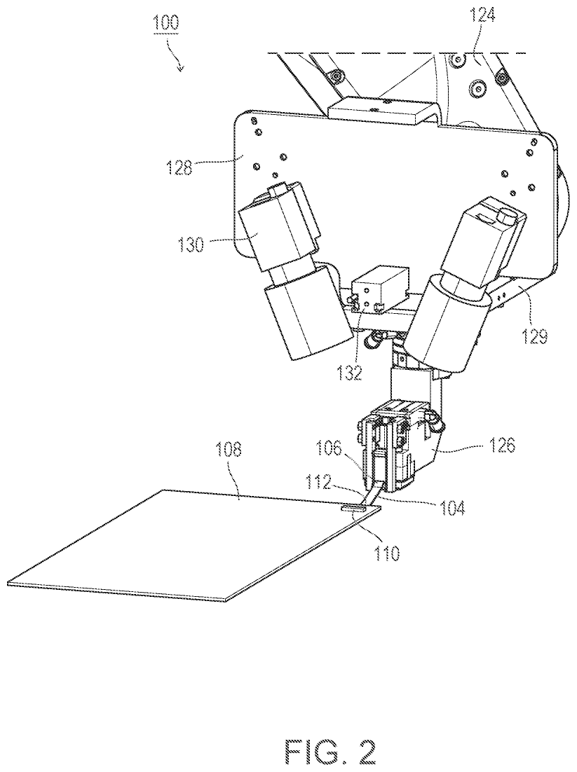

FIG. 1 is an overall configuration diagram of a robot system 102 to which an electronic device assembly apparatus 100 according to an embodiment of the present invention is applied. FIG. 2 is a diagram showing a part of the electronic device assembly apparatus 100 shown in FIG. 1. The electronic device assembly apparatus 100 is used at a production site such as a plant. The electronic device assembly apparatus 100 automatically performs connection work for electrically connecting (inserting) a leading end 106 of a cable 104 shown in FIG. 2 to a connector 110 on a circuit board 108, which is a connection target.

The cable 104 is a flat elongated cable having flexibility such as an FPC or an FFC. The cable 104 is highly flexible, and a portion of the cable 104 can be bent in an arc shape. The cable 104 includes a base 112 that is electrically connected to the circuit board 108, and the leading end 106 of the cable 104 is in a lying state. Note that the lying state is a state in which the cable 104 also extends substantially horizontally with the circuit board 108 extending substantially horizontally when the base 112 of the cable 104 has been electrically connected (soldered) to the circuit board 108 in an actual production process performed at the production site.

The electronic device assembly apparatus 100 includes a robot body 113 shown in FIG. 1 and a robot controller 114 connected to the robot body 113. The robot system 102 includes an upper-level control system 116, an input device 118, and a state notification device 120 that are connected to the robot controller 114, in addition to the electronic device assembly apparatus 100. The input device 118 is a device for inputting commands, parameters, and the like to the robot controller 114. The state notification device 120 is a device that receives and displays an operation state of the robot body 113 and a state of the connection work, which are transmitted from the robot controller 114.

The robot body 113 includes a base portion 122 shown in FIG. 1, a robot arm 124 connected to the base portion 122, a gripping device 126, and a visual device 128. The gripping device 126 is attached to a leading end 129 of the robot arm 124 as shown in FIG. 2 and grips the cable 104.

As shown in FIG. 2, the visual device 128 is an imaging device that captures images of the cable 104 and the like. The visual device 128 is attached so as to face downward toward the leading end 129 of the robot arm 124. The visual device 128 includes a camera 130, which is a visual sensor, and a lighting device 132 that lights up the circuit board 108 and the cable 104.

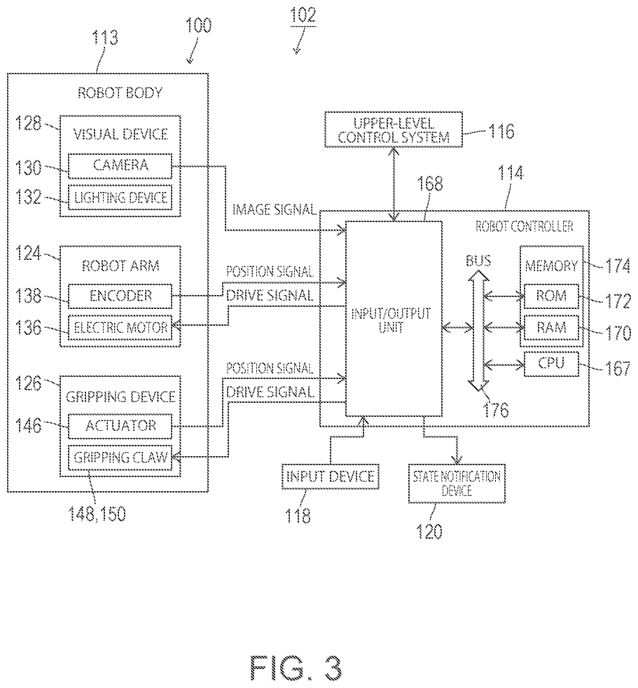

FIG. 3 is a block diagram showing functions of the robot system 102 shown in FIG. 1. The robot arm 124 is a six-axis vertical articulated robot, and includes electric motors 136, which are actuators provided at joints of the robot arm, and encoders 138 that detect positions of the joints. The encoders 138 output position signals indicating detection results of the positions of the joints to the robot controller 114. The robot controller 114 generates drive signals for driving the electric motors 136 based on the position signals received from the encoders 138. The electric motors 136 are driven by the drive signals output from the robot controller 114 and realize target operations of the robot arm 124 in the connection work.

With this configuration, the robot arm 124 can move the gripping device 126 attached to its leading end 129 as shown in FIG. 2 to a predetermined position. Note that the robot arm 124 is not limited to a six-axis vertical articulated robot, and may also be a vertical articulated robot in which the number of axes is not six, or a horizontal articulated robot, for example.

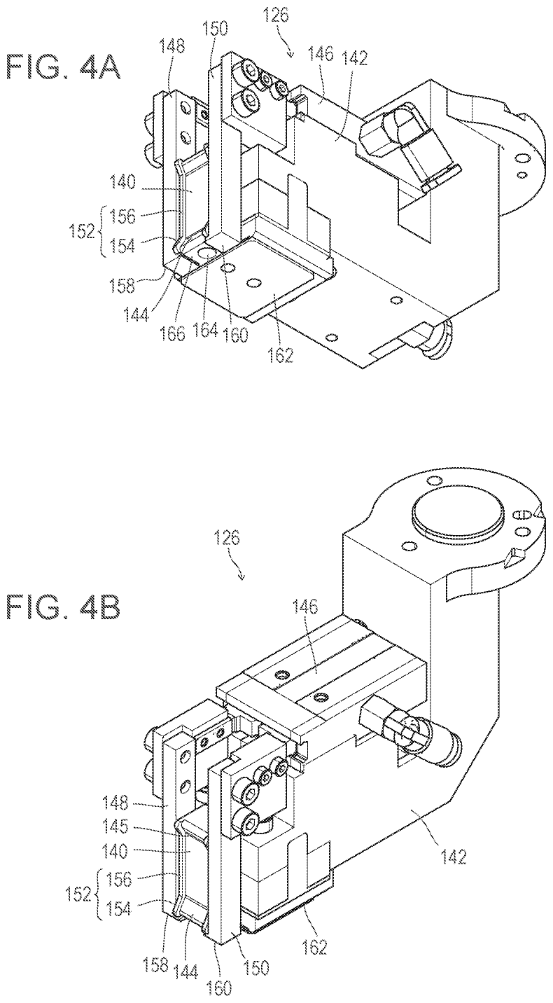

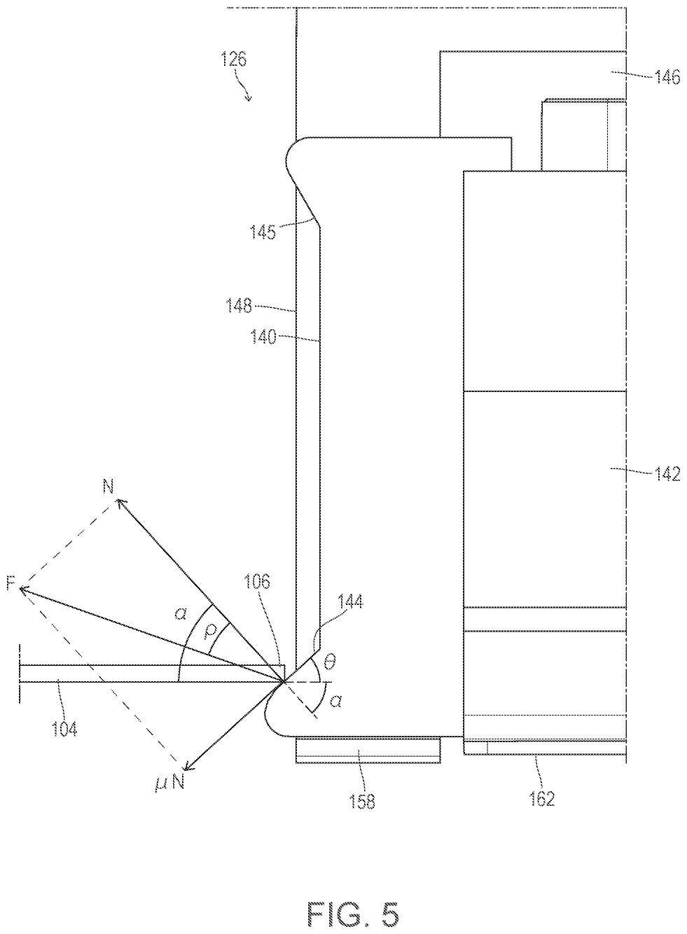

FIG. 4A is a diagram showing the gripping device 126 as viewed from obliquely below, and FIG. 4B is a diagram showing the gripping device 126 as viewed from obliquely above. FIG. 5 is a diagram showing conditions for making the leading end 106 of the cable 104 stand up with use of the gripping device 126 shown in FIG. 4.

The gripping device 126 includes a guide member 140 and a holding member 142. The guide member 140 includes a scooping surface 144 and a turn-over surface 145. The holding member 142 includes an actuator 146 and a pair of gripping claws 148 and 150. The gripping claws 148 and 150 perform opening and closing operations so as to approach each other or separate from each other in response to being driven by the actuator 146, and thus hold the cable 104 by sandwiching two side surfaces of the cable 104 in a direction (e.g., a width direction) intersecting the longitudinal direction, or release the cable 104.

The scooping surface 144 of the guide member 140 has an angle θ set such that an upward force is applied to the leading end 106 of the cable 104 due to a relationship between a pressure angle α and a friction angle ρ in a state where the scooping surface 144 is in contact with the leading end 106 of the lying cable 104 as shown in FIG. 5.

Specifically, a force F that is applied by the scooping surface 144 to the leading end 106 of the cable 104 due to the scooping surface 144 coming into contact with the leading end 106 of the lying cable 104 can be broken down into a normal component of reaction N of the scooping surface 144 and a frictional force μN acting along a surface direction of the scooping surface 144. Note that μ represents a friction coefficient.

As shown in FIG. 5, the pressure angle α is an angle between the longitudinal direction of the cable 104 and the normal component of reaction N. The friction angle ρ is an angle between the direction of the force F and the normal component of reaction N. Therefore, the following formula (1) holds for the friction angle ρ and the friction coefficient μ.

$$tan ρ = μ N / N = μ \qquad ( 1 )$$

Furthermore, an inverse function of the above formula (1) is expressed by the following formula (2).

$$ρ = {tan}^{- 1} μ \qquad ( 2 )$$

When the relationship between the pressure angle α and the friction angle ρ satisfies the following formula (3), the force F includes an upward component and an upward force is applied to the leading end 106 of the cable 104.

$$α - ρ > 0 \qquad ( 3 )$$

When the friction angle ρ calculated using the formula (2) is substituted into the formula (3) to make the left hand side the pressure angle α, the following formula (4) is obtained.

$$α > {tan}^{- 1} μ \qquad ( 4 )$$

Also, the following formula (5) holds for the angle θ of the scooping surface 144 and the pressure angle α.

$$α + θ = π / 2 \qquad ( 5 )$$

Based on the above formulas (4) and (5), the angle θ of the scooping surface 144 is set such that the following formula (6) holds.

$$θ < π / 2 - {tan}^{- 1} μ \qquad ( 6 )$$

As shown in FIG. 4, protrusions 152 are respectively provided on two side surfaces of the guide member 140. The protrusions 152 include introducing portions 154 and parallel portions 156. The introducing portions 154 are provided on two side surfaces of the scooping surface 144 and are inclined in such a manner as to increasingly protrude while extending downward. The parallel portions 156 are continuous to the introducing portions 154 and extend in parallel to the longitudinal direction of the cable 106.

When the leading end 106 of the lying cable 104 comes into contact with the scooping surface 144 of the guide member 140 and is subjected to an upward component of the force F (see FIG. 5), the leading end 106 warps upward and is introduced further upward by the introducing portions 154 of the protrusions 152, and side surfaces of the leading end 106 are guided by the parallel portions 156.

The distance between the parallel portions 156 provided on two side surfaces of the guide member 140 is set such that there is a clearance between the parallel portions 156 and the side surfaces of the cable 104 in the state where the side surfaces of the leading end 106 of the cable 104 are guided by the parallel portions 156. Thus, the distance is set to enable the cable 104 to slide. As described above, the protrusions 152 of the guide member 140 allow the leading end 106 of the cable 104 to slide in the longitudinal direction of the guide member 140, and restrict movement of the leading end 106 in the width direction.

The electronic device assembly apparatus 100 can bring the scooping surface 144 of the guide member 140 into contact with the leading end 106 of the cable 104 (see FIG. 5) by controlling the robot body 113 (see FIG. 1) with use of the robot controller 114 to move the gripping device 126. Furthermore, the electronic device assembly apparatus 100 further advances the gripping device 126 toward the circuit board 108 in the state where the scooping surface 144 of the guide member 140 is in contact with the leading end 106 of the cable 104. As a result, the leading end 106 of the cable 104 warps upward and slides upward, and thus it is possible to make the cable 104 stand up (as described later).

Also, in the electronic device assembly apparatus 100, when the leading end 106 of the cable 104 slides upward, two side surfaces of the leading end 106 of the cable 104 can be guided not only by the protrusions 152 provided on two side surfaces of the guide member 140 but also by inner side surfaces of the gripping claws 148 and 150.

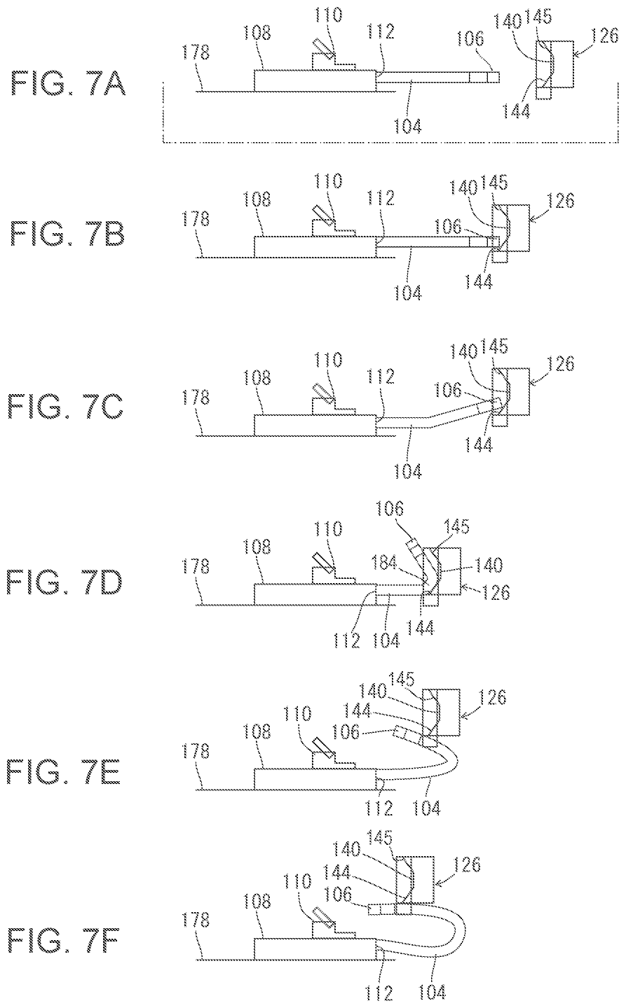

Furthermore, as shown in FIG. 4, lower portions 158 and 160 of the gripping claws 148 and 150 are located below the scooping surface 144 of the guide member 140 and protrude downward past a lower surface 162 of the holding member 142 (see FIG. 5). After the lying cable 104 has been caused to stand up, the electronic device assembly apparatus 100 further advances the gripping device 126 toward the circuit board 108. Thus, the cable 104 is folded (see FIG. 7), and two side surfaces of the folded cable 104 are sandwiched between the lower portions 158 and 160 of the gripping claws 148 and 150.

The lower portions 158 and 160 of the gripping claws 148 and 150 protrude inward toward each other as shown in FIG. 4. This configuration prevents the cable 104 from falling down after the folded cable 104 has been sandwiched. However, the shape of the lower portions 158 and 160 of the gripping claws 148 and 150 is not limited to this shape, and the lower portions may also have a recessed shape so as to receive the sandwiched cable 104 from below.

The guide member 140 further includes a suction hole 164 shown in FIG. 4A serving as a suction member. The suction hole 164 is formed in a lower surface 166 of the guide member 140, which comes into contact with the cable 104 that has been caused to stand up from the lying state and then folded.

The suction hole 164 is in communication with a vacuum pressure creating source such as an ejector, and a vacuum is created by feeding compressed air to the ejector through an operation of a solenoid valve (not shown). The cable 104 is held by the suction hole 164 through vacuum suction performed via the suction hole 164 in a state where the lower surface of the guide member is in contact with a surface of the cable 104 after the cable 104 is folded. The solenoid valve that controls the suction hole 164 is provided in an element included in the robot system 102 and operates upon receiving a drive signal from the robot controller 114.

The suction hole 164 is provided between the lower portions 158 and 160 of the gripping claws 148 and 150 as shown in FIG. 4A. Therefore, the cable 104 sandwiched between the lower portions 158 and 160 of the gripping claws 148 and 150 is also sucked and held by the suction hole 164, and thus the cable 104 can be reliably held.

Here, the elements shown in FIG. 3 will be described in detail. The camera 130 and the lighting device 132 included in the visual device 128 are attached to the leading end 129 of the robot arm 124 (see FIG. 1), but there is no limitation to this configuration, and the camera and the lighting device may be provided at a position other than the robot arm 113 so long as an overhead image of a work area of the connection work can be obtained. At least one camera 130 needs to be provided, and it is preferable to provide two or more cameras in order to enhance imaging precision. The camera 130 may obtain color images or monochrome images.

In the case where the camera 130 is a monocular camera, three-dimensional imaging information can be estimated with use of known SLAM (Simultaneous Localization and Mapping) technology. However, in this case, the camera 130 needs to be moved while taking images. Note that, in principle, the camera 130 can obtain only a relative value of distance, but when positional information of the camera 130 can be obtained from the robot controller 114, it is possible to obtain positional information in a robot coordinate system.

In the case where the camera 130 is a stereo camera, positional information can be obtained from parallax information obtained through known stereo matching. In the case where the camera 130 is a multi-view camera, the principle is the same as that of the stereo camera, and parallax images taken from various directions can be obtained, and therefore, occlusion is unlikely to occur. In the case where the camera 130 is a TOF (Time of Flight) camera, positional information can be obtained based on the time it takes to receive light reflected from a subject after the light is emitted toward the subject. In the case where the camera 130 uses emitted light, positional information can be obtained by performing known pattern projection (projection of a stripe pattern or a random dot pattern).

The lighting device 132 is installed in a surrounding region of a lens of the camera 130 for capturing images, for example, and lights up the cable 104 to be gripped by the gripping device 126 and the connector 110 on the circuit board 108 to which the cable is to be connected, but there is no limitation to this configuration, and the lighting device may also emit pattern light when measuring a distance.

As shown in FIG. 3, the robot controller 114 includes a CPU 167, an input/output unit 168 for inputting and outputting signals, and a memory 174 including a RAM 170 and a ROM 172. The CPU 167, the input/output unit 168, and the memory 174 are connected to each other via a bus 176 in such a manner that signals can be transmitted therebetween.

The CPU 167 functions as an arithmetic processing device, accesses the memory 174, and reads out and executes various programs stored in the RAM 170, the ROM 172, an external storage device, or the like. The RAM 170 and the ROM 172 are computer-readable recording mediums including programs recorded thereon for controlling the robot body 113, i.e., executing an electronic device assembly method. For example, a program and a device constant used by the CPU 167 are stored in the ROM 172. For example, a program used by the CPU 167 and a variable that varies successively during execution of the program are temporarily stored in the RAM 170. As described above, the robot controller 114 can control the robot body 113 and the gripping device 126 by executing various programs and cause the robot body 113 and the gripping device 126 to execute various functions.

The input/output unit 168 of the robot controller 114 includes a communication device, a D/A converter, a motor drive circuit, an A/D converter, and the like, and connects the robot controller 114 to an external device, the electric motors 136, the actuator 146, and various sensors such as the encoders 138 via an interface. Examples of specific communication methods used by the communication device may include data communication in accordance with serial communication standards such as RS232C/485 or USB standards, EtherNET (registered trademark), which is a common network protocol, and EtherCAT (registered trademark) and EtherNet/IP (registered trademark), which are used as industrial network protocols.

The robot controller 114 may also be connected via the input/output unit 168 to a storage device for storing data or a drive device that is a reader-writer for recording mediums. The robot controller 114 is not limited to a controller in which dedicated hardware is incorporated, and may also be a general-purpose personal computer that can execute various functions when various programs are installed, for example.

Note that the robot controller 114 controls all of the robot arm 124, the gripping device 126, and the visual device 128, but there is no limitation to this configuration. For example, the robot controller 114 may be configured as a group of a plurality of controllers that respectively control the robot arm 124, the gripping device 126, and the visual device 128, and the plurality of controllers may be connected to each other wirelessly or by cable. Furthermore, the robot controller 114 is provided outside the robot body 113 in the electronic device assembly apparatus 100, but there is no limitation to this configuration, and the robot controller 114 may also be provided inside the robot body 113.

The input device 118 includes an operation means to be operated by a user, such as a keyboard, a mouse, a touch panel, a button, a switch, a lever, a pedal, a remote control means that uses infrared rays or other radio waves, or a personal computer or teaching pendant including these devices. The user who performs the connection work uses the input device 118 to perform input and setting. Note that a program that causes the robot body 113 to execute various functions may be created with use of the input device 118. The program may be written in a low level language such as a machine language or a high level language such as a robot language.

The state notification device 120 receives information regarding an operation state of the robot body 113 and information regarding a state of the leading end 106 of the cable 104 inserted into the connector 110 on the circuit board 108 from the robot controller 114 and displays the information to enable the user to recognize the information visually and intuitively. The state notification device 120 may be a display device such as a liquid crystal panel, a teaching pendant, or a lighting lamp, or a notification device that gives notifications regarding information with use an alert sound or audio. For example, the state notification device 120 may be set so as to issue an alert when the connection work for inserting the leading end 106 of the cable 104 into the connector 110 has failed. Alternatively, a screen of a personal computer or a teaching pendant may serve as the state notification device 120. The state notification device 120 may include an application for performing input and notification of states.

The upper-level control system 116 is constituted by, for example, a sequencer (PLC), a monitoring and control system (SCADA), a process computer (PROCOM), a personal computer, various servers, or a combination thereof, and connected to the robot controller 114 wirelessly or by cable. The upper-level control system 116 outputs instructions based on operation states of devices that constitute a production line including the robot controller 114, and comprehensively controls the production line.

The upper-level control system 116 can also be used to monitor a defect rate or a cycle time or inspect products by receiving and collecting the time it takes to complete the connection work, a state after the connection work is complete, or the like from the robot controller 114. Furthermore, the upper-level control system 116 may obtain information regarding a state of the operation for gripping the cable 104 with the gripping device 126 of the robot body 113 from the robot controller 114 to cause the robot arm 124 to return to a home position or stop each device.

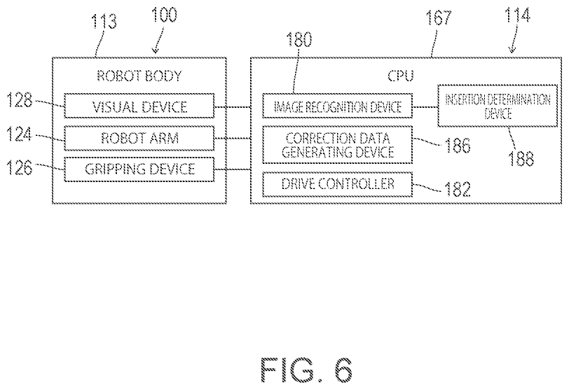

Next, operations of the electronic device assembly apparatus 100 will be described. FIG. 6 is a block diagram showing functions of the electronic device assembly apparatus 100 shown in FIG. 3. FIG. 6 shows functional blocks of the robot body 113 of the electronic device assembly apparatus 100 and functional blocks of the CPU 167 of the robot controller 114. FIGS. 7A to 7F are diagrams showing connection work for connecting the cable 104 with use of the gripping device 126 shown in FIG. 4.

First, in the electronic device assembly apparatus 100, after the circuit board 108 is placed on a table 178 shown in FIG. 7A, an image recognition device 180 of the CPU 167 recognizes the position and type of the cable 104 based on an image signal obtained from the visual device 128 of the robot body 113. As long as an image signal can be generated, there is no limitation to the configuration in which the visual device 128 is used, and an image of the cable 104 may be obtained with use of a fixed camera installed at a position from which the work area can be viewed from above.

Next, a drive controller 182 outputs a drive signal to the robot arm 124 based on the result of recognition by the image recognition device 180 to cause the robot arm 124 to operate and move the gripping device 126 to a position at which the gripping device 126 faces the leading end 106 of the cable 104 in the longitudinal direction of the lying cable 104 as shown in FIG. 7A.

Then, the drive controller 182 advances the gripping device 126 toward the circuit board 108 to bring the scooping surface 144 of the guide member 140 into contact with the leading end 106 of the cable 104 (see FIG. 7B). Subsequently, the gripping device 126 is further advanced substantially horizontally toward the circuit board 108 (see FIG. 7C). As a result, the leading end 106 of the cable 104 slides upward to stand up while being guided by the guide member 140 (see FIG. 7D). At this time, the leading end 106 of the cable 104 is pushed toward the circuit board 108 by the guide member 140, and thus the cable 104 is curved along the scooping surface 144.

Note that, when the scooping surface 144 of the guide member 140 has come into contact with the leading end 106 of the cable 104, the robot arm 124 is operated so as to move the gripping device 126 substantially horizontally, but the direction of the operation can be selected as appropriate as long as the gripping device can come into contact with the leading end 106 of the cable 104 at an angle that produces an upward force applied to the leading end, i.e., at the pressure angle α (see FIG. 5).

As shown in FIG. 7D, when the leading end 106 of the cable 104 stands up and moves upward, the cable is folded toward the circuit board 108 by the turn-over surface 145 provided in an upper portion of the guide member 140. At this time, an intermediate portion 184 of the cable 104 is in contact with the guide member 140. In this state, the drive controller 182 moves the gripping device 126 upward, for example, to fold the standing cable 104 (see FIG. 7E) while further advancing the gripping device 126 toward the circuit board 108. As a result, the folded cable 104 is sandwiched between the lower portions 158 and 160 of the gripping claws 148 and 150 of the holding member 142 (see FIG. 4) and prevented from falling down. Note that FIG. 7F shows a state where the vicinity of the leading end 106 of the folded cable 104 is sandwiched by the lower portion 158 of the gripping claw 148. Thereafter, the cable 104 comes into contact with the lower surface 166 of the guide member 140 shown in FIG. 4A and is reliably held by being sucked via the suction hole 164 formed in the lower surface 166.

Next, as shown in FIG. 7F, the drive controller 182 further moves the gripping device 126 gripping the cable 104 to the vicinity of the connector 110 on the circuit board 108. The electronic device assembly apparatus 100 can correct the posture of the cable 104 with use of the guide member 140 while moving the gripping device 126, if an approximate position of the leading end 106 of the cable 104 is recognized, and therefore, quick operation is possible.

Next, the leading end 106 of the cable 104 is aligned with the connector 110. However, positions of the connector and the leading end of the cable relative to each other at the time of the alignment may vary due to a positional error made in the operation of gripping the cable 104 with the gripping device 126, an installation error made when the circuit board 108 is placed on the table 178 (see FIG. 7), a positional error made when the connector 110 is mounted on the circuit board 108, or the like.

Therefore, a correction data generating device 186 of the CPU 167 generates position correction data based on data obtained through recognition by the image recognition device 180, and thus, the electronic device assembly apparatus 100 absorbs variation in the positions of the connector and the leading end of the cable relative to each other. The drive controller 182 can correct a positional error and a posture error by moving the gripping device 126 based on the position correction data. For example, the drive controller 182 extracts feature points of the cable 104 and the connector 110, calculates a position correction amount that realizes an appropriate positional relationship between the feature points, and moves the gripping device 126 and the cable 104.

After alignment between the connector 110 and the leading end 106 of the cable 104 is completed, the drive controller 182 inserts the leading end 106 of the cable 104 into the connector 110 by moving the gripping device 126. Note that correction of the positions can be omitted as appropriate depending on conditions such as positional accuracy of the cable 104 and the connector 110.

Next, an image of the connector 110 and the cable 104 inserted into the connector 110 is captured by the visual device 128, and an insertion determination device 188 of the CPU 167 compares the image with an image of a case where insertion is successful. When it is determined through the comparison that the insertion is successful, i.e., the connection work is complete, the processing is ended. On the other hand, when it is determined by the insertion determination device 188 that the insertion has failed, the insertion determination device 188 may notify the upper-level control system 116 or the user of the occurrence of an abnormality via the state notification device 120 shown in FIG. 3. Also, some measures may be taken such as retrying the connection work. It is also possible to omit automatic determination by the robot system 102 and inspect the circuit board 108 in another step after the insertion is complete.

In the robot system 102 to which the electronic device assembly apparatus 100 is applied, it is possible to make the lying cable 104 stand up by simply moving the gripping device 126. Then, the standing cable 104 is folded and the leading end 106 is inserted into the connector 110 on the circuit board 108. Thus, the connection work can be completed quickly and the work efficiency can be increased.

While a preferred embodiment of the present invention has been described with reference to the attached drawings, it goes without saying that the present invention is not limited to the embodiment. It is clear that those skilled in the art will be able to arrive at various changes and modifications within the scope of the claims, and those changes and modifications are understood to naturally fall within the technical scope of the present invention.

This application is based upon and claims the benefit of priority from the prior Japanese Patent Application No. 2021-110783, filed on Jul. 2, 2021, the above contents are cited in the specification, claims, and drawings of the present application.

### INDUSTRIAL APPLICABILITY

The present invention can be used as an electronic device assembly apparatus and an electronic device assembly method for gripping a cable connected to a circuit board of an electronic device or the like.

### INDEX TO THE REFERENCE NUMERALS

100 . . . electronic device assembly apparatus; 102 . . . robot system; 104 . . . cable; 106 . . . leading end of cable; 108 . . . circuit board; 110 . . . connector; 112 . . . base of cable; 113 . . . robot body; 114 . . . robot controller; 116 . . . upper-level control system; 118 . . . input device; 120 . . . state notification device; 122 . . . base portion; 124 . . . robot arm; 126 . . . gripping device; 128 . . . visual device; 129 . . . leading end of robot arm; 130 . . . camera; 132 . . . lighting device; 136 . . . electric motor; 138 . . . encoder; 140 . . . guide member; 142 . . . holding member; 144 . . . scooping surface; 145 . . . turn-over surface; 146 . . . actuator; 148, 150 . . . gripping claw; 152 . . . protrusion; 154 . . . introducing portion; 156 . . . parallel portion; 158, 160 . . . lower portion of gripping claw; 162 . . . lower surface of holding member; 164 . . . suction hole; 166 . . . lower surface of guide member; 167 . . . . CPU; 168 . . . input/output unit; 170 . . . . RAM; 172 . . . . ROM; 174 . . . memory; 176 . . . bus; 178 table; 180 image recognition device; 182 . . . drive controller; 184 intermediate portion of cable; 186 . . . correction data generating device; 188 insertion determination device

1. An electronic device assembly apparatus comprising:
a gripping device that grips a flexible flat cable including a leading end that is lying substantially horizontally;
a robot arm that moves the gripping device relative to a circuit board to which a base of the cable has been electrically connected; and
a robot control device that controls operations of the gripping device and the robot arm,
wherein the gripping device includes: a guide member having a scooping surface; and
a holding member that holds the cable guided by the guide member, and
the robot control device moves the gripping device to a position at which the gripping device faces the leading end of the cable in a longitudinal direction of the lying cable, brings the scooping surface of the guide member into contact with the leading end of the cable, and further advances the gripping device toward the circuit board to make the cable stand up.

2. The electronic device assembly apparatus according to claim 1,
wherein the holding member includes gripping claws that are operated by an actuator, and
the gripping claws hold the cable by sandwiching the cable in a direction longitudinally intersecting the cable.

3. The electronic device assembly apparatus according to claim 1,
wherein the gripping device further includes a suction member that is provided in a lower surface of the gripping device and holds the cable by sucking the cable.

4. The electronic device assembly apparatus according to claim 1,
wherein the robot control device moves the gripping device substantially horizontally to fold the cable that has been caused to stand up, causes the holding member to hold the leading end of the cable, and inserts the leading end of the cable into a connector on the circuit board.

5. An electronic device assembly method for inserting a leading end of a flexible blat cable into a connector on a circuit board, the cable including a base that has been connected to the circuit board and the leading end that is lying substantially horizontally, the method comprising:
moving a gripping device including: a guide member having a scooping surface; and a holding member that holds the cable guided by the guide member;
placing the gripping device so as to face the leading end of the lying cable;
bringing the scooping surface of the guide member into contact with the leading end of the cable and advancing the gripping device toward the circuit board to make the cable stand up; and
moving the gripping device substantially horizontally to fold the cable that has been caused to stand up, causing the holding member to hold the leading end of the cable, and inserting the leading end of the cable into the connector on the circuit board.

6. The electronic device assembly apparatus according to claim 2,
wherein the gripping device further includes a suction member that is provided in a lower surface of the gripping device and holds the cable by sucking the cable.

7. The electronic device assembly apparatus according to claim 2,
wherein the robot control device moves the gripping device substantially horizontally to fold the cable that has been caused to stand up, causes the holding member to hold the leading end of the cable, and inserts the leading end of the cable into a connector on the circuit board.

8. The electronic device assembly apparatus according to claim 3,
wherein the robot control device moves the gripping device substantially horizontally to fold the cable that has been caused to stand up, causes the holding member to hold the leading end of the cable, and inserts the leading end of the cable into a connector on the circuit board.

9. The electronic device assembly apparatus according to claim 6,
wherein the robot control device moves the gripping device substantially horizontally to fold the cable that has been caused to stand up, causes the holding member to hold the leading end of the cable, and inserts the leading end of the cable into a connector on the circuit board.
